(19) United States
(12) Patent Application Publication
(10) Pub. No.: US 2026/0105251 A1
(43) Pub. Date: Apr. 16, 2026

(54) DETERMINING REPORTABLE EVENTS OF EVENT LOGS FOR A NUCLEAR POWER GENERATION PLANT

(71) Applicants: Florida Power & Light Company, Juno Beach, FL (US); Inventus Holdings, LLC, Juno Beach, FL (US)

(72) Inventors: Namasivayam Piraviperumal Bala Selva, Westlake, FL (US); Earl S. Midgett, Stuart, FL (US); Natasha R. Menon, Port St. Lucie, FL (US); Diego F. Lopez, Jacksonville, FL (US); Hany F. Bassily, Oviedo, FL (US); Ashwin K. Kunduru, Wellington, FL (US); Ricardo L. Rivera, Palm City, FL (US)

(21) Appl. No.: 18/916,435

(22) Filed: Oct. 15, 2024

(51) Int. Cl. G06F 40/279

(52) U.S. Cl. CPC G06F 40/279

(57) ABSTRACT

Employing artificial intelligence to generate regulatory reports is discussed. One example is a machine-readable medium having machine executable instructions for a regulatory reporting system that causes a processor core to execute operations. The operations include assigning a set of labels to an event log of a set of event logs based on applying a pattern matching algorithm to the event log. The event log characterizes a portion of an event associated with a nuclear power plant. The operations also include employing a natural language processor (NLP)-based classifier of a set of NLP-based classifiers to determine whether the event is reportable. The NLP-based classifier determines whether the event is reportable based on analyzing the set of labels. Additionally, the operations include generating a regulatory report based on the set of event logs. In response to a determination that the event log is reportable, the regulatory report indicates the event.

### TECHNICAL FIELD

This description relates to systems and methods for determining reportable events from event logs of a nuclear power generation plant using artificial intelligence.

### BACKGROUND

In many industries, reports are prepared periodically for regulatory agencies and associated entities. In the nuclear power industry, the Institute of Nuclear Power Operations (INPO) evaluates safety issues at nuclear power plants, including through reports provided to INPO via the Industry Reporting and Information System (IRIS) (or to the World Association of Nuclear Operators (WANO)) indicating reportable events at nuclear power plants. Failure to include events deemed reportable in regulatory reports can lead to sanctions such as fines.

### SUMMARY

A first example relates to a non-transitory machine-readable medium having machine executable instructions for a regulatory reporting system that causes a processor core to execute operations. The operations include assigning a set of labels to an event log of a set of event logs based on applying a pattern matching algorithm to the event log. The event log characterizes a portion of an event associated with a nuclear power plant. The operations also include employing a natural language processor (NLP)-based classifier of a set of NLP-based classifiers to determine whether the event is reportable. The NLP-based classifier determines whether the event is reportable based on analyzing the set of labels. The operations additionally include generating a regulatory report based on the set of event logs. In response to a determination that the event log is reportable, the regulatory report indicates the event.

A second example relates to a regulatory reporting system that includes a memory for storing machine-readable instructions and a processor core for accessing the machine-readable instructions and executing the machine-readable instructions as operations. The operations include assigning a set of labels to an event log of a set of event logs based on applying a pattern matching algorithm to the event log. The event log characterizes a portion of an event associated with a nuclear power plant. The operations also include employing a natural language processor (NLP)-based classifier of a set of NLP-based classifiers to determine whether the event is reportable. The NLP-based classifier determines whether the event is reportable based on analyzing the set of labels. The operations additionally include generating a regulatory report based on the set of event logs. In response to a determination that the event log is reportable, the regulatory report indicates the event.

A third example relates to a method for generating a regulatory report. The method includes assigning a set of labels to an event log of a set of event logs based at least in part on applying a pattern matching algorithm to the event log. The event log characterizes at least a portion of an event associated with a nuclear power plant. The method also includes analyzing time series data from a sensor that monitors an equipment associated with the event to extract discrete data that characterizes the behavior of the equipment. The method additionally includes generating descriptive text that characterizes the time series data by applying a natural language generator to the discrete data. The method further includes employing a natural language processor (NLP)-based classifier of a set of NLP-based classifiers to determine whether the event is reportable. The NLP-based classifier determines whether the event is reportable based at least in part on analyzing the set of labels and the descriptive text. Additionally, the method includes generating a regulatory report based on the set of event logs. In response to a determination that the event log is reportable, the regulatory report indicates the event.

### BRIEF DESCRIPTION OF THE DRAWINGS

FIG. 1 illustrates a diagram showing a regulatory reporting system that generates regulatory reports for submission to regulatory agencies or associated entities via artificial intelligence (AI) and/or machine learning (ML) models, in accordance with an example.

FIG. 2 illustrates a table showing example operator log entries in connection with a nuclear power plant.

FIG. 3 illustrates a table that includes example data associated with a regulatory report for a nuclear power plant.

FIG. 4 illustrates an example computing environment for a regulatory reporting system.

FIG. 5 illustrates a flowchart of an example method for analyzing event logs and additional data sources associated with a nuclear power plant in connection with generating a regulatory report.

FIG. 6 illustrates a flowchart of an example method for generating a regulatory report for a nuclear power plant.

FIG. 7 illustrates a flowchart of an example method for training and employing a pattern matching algorithm to generate a set of labels for an event log related to a nuclear power plant.

### DETAILED DESCRIPTION

In various industries, companies provide regulatory reports to various regulatory entities. In the nuclear power industry, plant operators generate periodic reports to INPO and/or WANO reports regarding certain events related to specific safety functions of a nuclear power plant. Failure to report events that were reportable can lead to legal sanctions, including fines. Manually determining which events are reportable involves reviewing operator logs to determine log entries associated with an event and determining from the log entries whether the event is reportable (e.g., as well as other characteristics, such as whether the event was planned, whether equipment associated with the event was operable during the event, etc.). Because manual report generation does not consider additional sources of data regarding events and equipment such as sensor data, an event might be omitted that would have been identified as reportable if more data were considered. Additionally, errors in operator log entries such as missing log entries or typographical errors can also lead to reportable events not being identified on a regulatory report.

Various examples described herein employ artificial intelligence (AI) to identify and recommend possible regulatory reportable events. In various examples, machine learning models are trained at least in part based on human feedback. Generative AI is employed by various examples to determine the start of an event, the end of the event, and/or the duration of the event. Pattern matching is employed by examples to associate labels with log entries. Various examples combine operator log entries with other data points, such as equipment sensor data, work orders/outages, etc. Natural language generation (NLG) is employed by various examples to generate language representing non-language data points (e.g., time series data, or data derived therefrom, etc.). Natural language processing (NLP) is used in various examples to classify an event as reportable or not based on log entries and/or other data points associated with the event. In various examples, additional NLP-based classifiers are used to determine additional characteristics of the event or equipment associated with the event, such as whether the equipment was operable during the event, whether the event was planned, etc.

Various examples facilitate operator review of monthly events for reporting unavailability hours to more efficiently meet INPO or WANO regulatory guidelines. Examples facilitate regulatory reporting such as mitigation system performance index (MSPI) reporting, for example, via automating operator log entry identification for potential reportable unavailability events (e.g., events associated with the unavailability of a specific subset of equipment, such as related to specific safety functions of a nuclear power plant, etc.). MSPI is a risk-informed, plant-specific performance indicator used by regulators and the nuclear power industry to track the performance of mitigating systems in nuclear power plants.

Examples facilitate automated identification of outage events based on AI analysis of operator log entries and/or other data sources. Criteria are established to determine unavailability measures for relevant equipment based on training a pattern matching algorithm that includes operator feedback (e.g., via a weak supervision model). Various examples generate an indication (e.g., via an IRIS-compatible report) of recommended reportable events based on NLP-based classifiers to determine characteristics of events (e.g., whether the event is reportable, planned, whether equipment associated with the event was operable, etc.) and/or generative AI to identify the start, end, and/or duration of events.

In various examples, engineering data and workflows are protected by integrating roles and permissions such as via enabling access controls based on roles and/or qualifications of user(s), etc. Various examples provide information to users to integrate human approval into the workflow of report generation. Generated indications of reportable events (e.g., in a suitable format for upload to a regulatory agency or associated entity or in another format) in a relevant time period are provided in various examples to user(s) for review and/or feedback, which can ensure the content of a report conforms to regulatory guidelines (e.g., from the Nuclear Regulatory Commission (NRC), etc.) prior to publication.

Additionally, various examples facilitate capturing electronic approval (e.g., electronic signatures, etc.) of reports, as well as automatic document generation and/or automatic routing of documents to designated parties (e.g., for audit processing purposes, etc.). Various examples also prepare reports for submission (e.g., after review, approval, etc.) to a regulatory agency or associated entity. Reports are generated by examples in formats suitable for submission and/or upload to the INPO IRIS or to WANO.

Examples provide multiple advantages over conventional manual techniques for preparation of regulatory reports related to nuclear power plants. These advantages include reducing preparation time for regulatory reports, curtailing redundancy in work such as multiple data entry, curtailing manual approval, and standardizing reporting over fleets of two or more nuclear power plants operated by the same entity. Additionally, various examples incorporate additional information (e.g., time series data, etc.) not included in conventional manual techniques, improving identification and characterization of events.

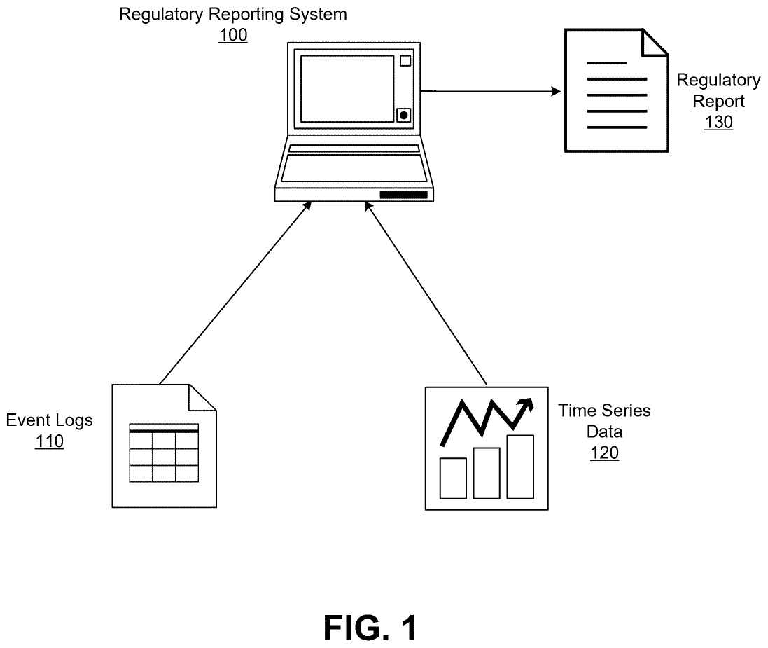

Referring to FIG. 1, illustrated is a diagram showing a regulatory reporting system 100 that generates regulatory reports 130 for submission to regulatory agencies or associated entities via artificial intelligence (AI) and/or machine learning (ML) models. The system 100 is communicatively coupled to an event logs database 110, which includes operator logs of events associated with a nuclear power plant (e.g., events associated with equipment at the nuclear power plant, etc.) in a relevant time period (e.g., a time period covered by the regulatory report, such as a month, etc.). The system 100 is also communicatively coupled to a time series database 120, which includes data for the relevant time period from additional sources such as equipment sensor data (e.g., from temperature sensors, pressure sensors, containment particulate and gas radiation sensors, etc.).

The system 100 generates a set of labels for each event log of the event logs database 110, for example, by employing a pattern matching algorithm (e.g., trained via a weak supervision model, etc.) to determine the set of labels for each event log. Additionally, the system 100 performs time series analysis (e.g., via statistical techniques such as an autoregressive integrated moving average (ARIMA), etc.) to generate discrete data that characterizes the time series data in the time series database 120. The system 100 also generates descriptive text based on the discrete data, for example, via a natural language generator (NLG).

The system 100 also applies a set of classifiers based on natural language processing (NLP) to event logs of the event logs database 110 associated with an event and to descriptive text generated based on time series data from the time series database 120 associated with the event. The set of NLP-based classifiers classify the event via a set of characteristics (e.g., reportable or not reportable, planned or not planned, associated with equipment that is operable or associated with equipment that is not operable, etc.).

Additionally, the system 100 determines the start, the end, and/or the duration of an event, for example, based on semantic analysis (e.g., via a generative AI model, etc.) of event logs associated with the event and descriptive text for time series data associated with the event.

Based on the identified events and the characteristics determined for the identified events by the system 100, the system 100 generates a regulatory report that indicates events determined by the system 100 to be reportable events. In various examples, the generated regulatory report is one of a preliminary regulatory report for review and/or feedback by one or more users or a finalized regulatory report in a format for submission to a regulatory agency or associated entity (e.g., for submission to INPO via IRIS, submission to WANO, etc.). In various examples, the system 100 additionally trains AI/ML models based on the user feedback to the generated regulatory report.

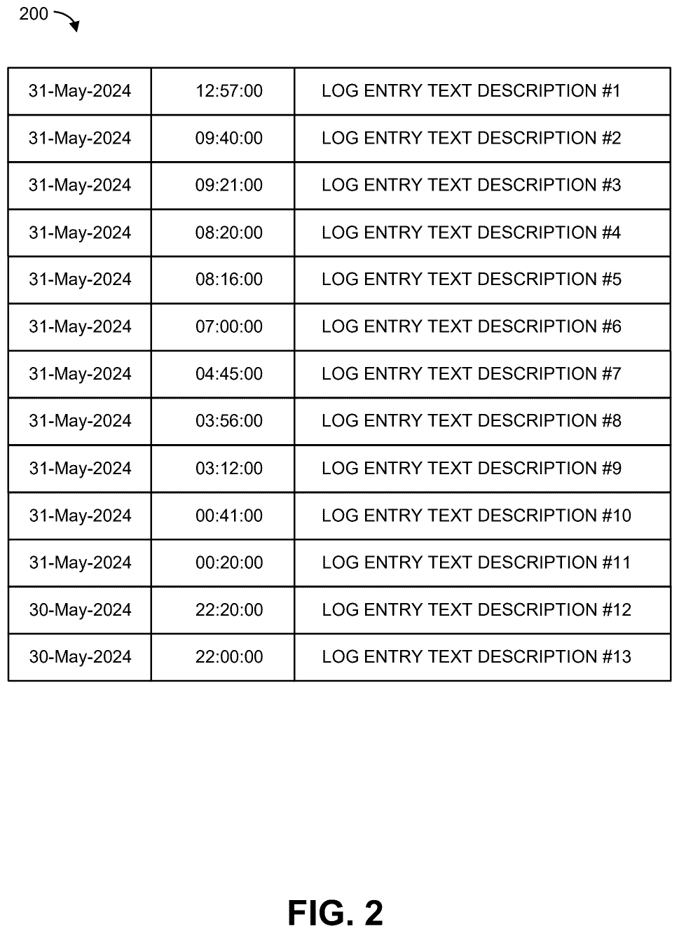

Referring to FIG. 2, illustrated is a table showing example operator log entries in connection with a nuclear power plant. As seen in FIG. 2, individual log entries include operator narratives related to events, along with the date and time of the log entry. Manual report generation involves determining, based on manual review of the log entries, the log entries associated with an event, the start and end of the event, as well as relevant characteristics of the event (e.g., whether the event is reportable, whether equipment associated with the event was operable during the event, whether the event was planned, etc.). One example log entry is a first log entry with a log entry text description #1 that in one example indicates performing manual dilution of primary water to maintain reactor power and control a reactor coolant system (RCS) temperature. Another example log entry is a second log entry with a log entry text description #2 that in one example indicates completion of testing and/or maintenance of a mitigation system or sensor system, such as containment particulate and gas radiation monitors, and whether the system is operable or inoperable, etc.

In contrast to manual report generation, various examples (e.g., regulatory reporting system 100 of FIG. 1, etc.) employ AI and/or ML models to identify log entries associated with an event, for example, via a pattern matching algorithm employed by a weak supervision model to assign a set of labels to each log entry. Examples identify an event, such as based on assigned labels. Additionally, other sources of data (e.g., time series data from sensors, etc.) associated with the event are analyzed (e.g., by determining discrete data associated with the time series data using statistical techniques such as an ARIMA model, etc.) by examples that generate descriptive text (e.g., via NLG) characterizing the other sources of data. Manual report generation is based on manual review of operator logs without including additional sources of data such as time series data from sensors, etc. Examples employ a set of NLP-based classifiers to determine a set of characteristics for the event based on the set of labels and the descriptive text characterizing the other sources of data. In various examples, the set of NLP-based classifiers include a first classifier to determine whether the event is reportable, a second classifier to determine whether the event was planned, a third classifier to determine whether equipment associated with the event was operable during the event, etc. In contrast to manual determination of the start and end of an event, various examples determine the start, end, and/or duration of the event via semantic analysis (e.g., by employing a generative AI, etc.). Additionally, event analysis by examples discussed herein is able to identify gaps where a log entry that is expected to be associated with an event is missing (e.g., a missing log entry indicating a start or end of an event, etc.), such as due to a typographical error in the relevant log entry.

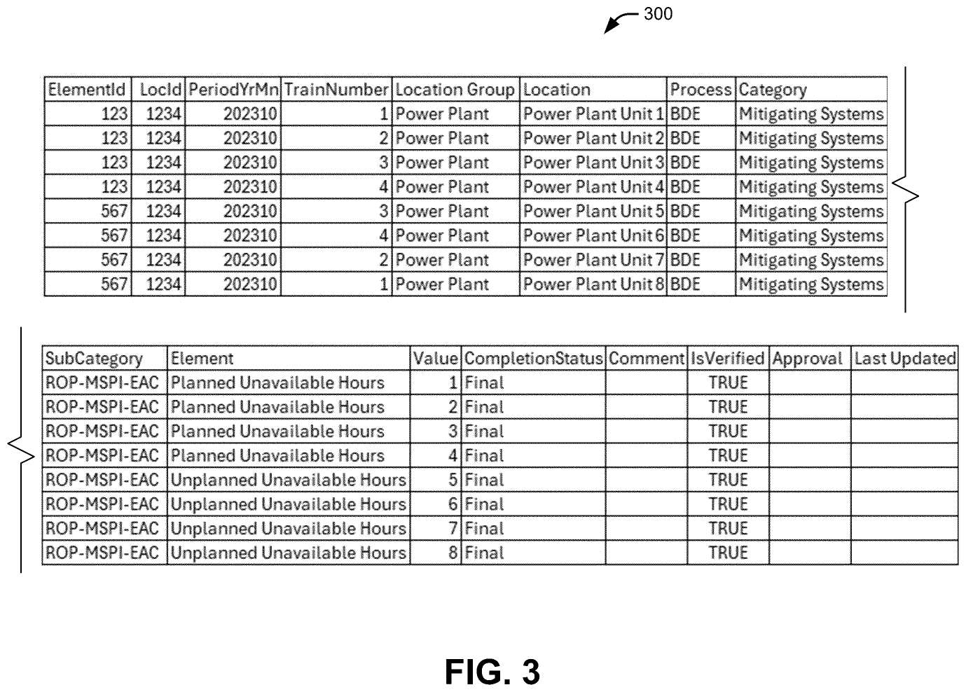

Referring to FIG. 3, illustrated is a table 300 that includes example data associated with a regulatory report for a nuclear power plant. The example table 300 of FIG. 3 includes data similar to what is submitted in reports to INPO via IRIS or to WANO, based on example reportable events. In various examples, regulatory reports generated by examples are formatted for upload to INPO IRIS or to WANO.

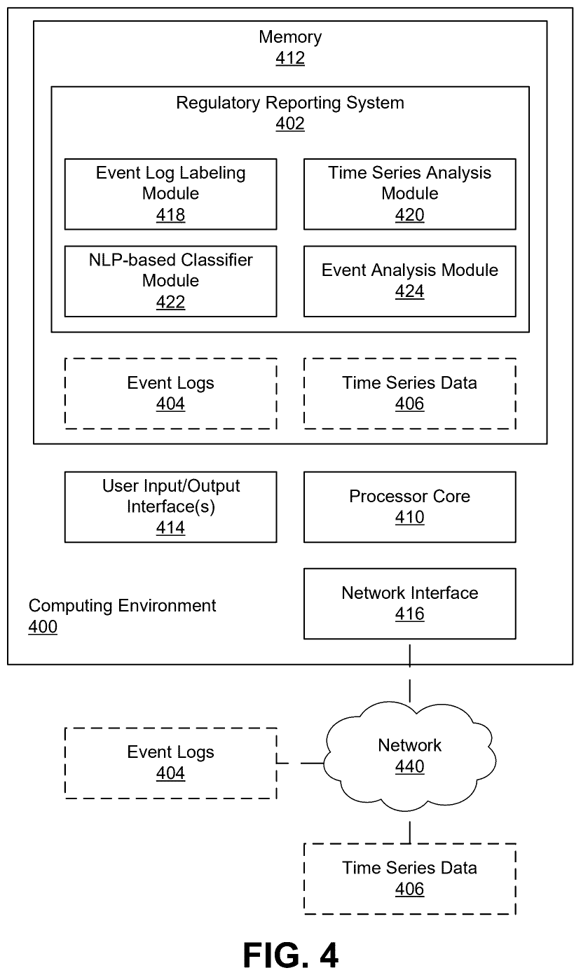

FIG. 4 illustrates an example computing environment 400 implementing a regulatory reporting system 402 capable of generating a regulatory report for a nuclear power plant based on analysis of operator event logs (e.g., in an event logs database 404 as one example of the event logs database 110 of FIG. 1) and additional sources of data (e.g., time series data in a time series database 406 as one example of the time series database 120 of FIG. 1). The computing environment 400 includes a processor core 410, a memory 412, a user input/output (I/O) interface 414, and a network interface 416, which are operably connected for computer communication. The processor core 410 performs general computing to execute instructions stored in the memory 412, including instructions associated with regulatory reporting system 402. The instructions cause the processor core 410 to execute operations. The memory 412 also stores instructions associated with an operating system that controls and/or allocates resources of the computing environment 400, including resources associated with the regulatory reporting system 100 of FIG. 1. The memory 412 represents a non-transitory machine-readable memory (or other medium), such as random-access memory (RAM), a solid state drive, a hard disk drive or a combination thereof.

The example computing environment 400 implements a regulatory reporting system 402, which is employable to implement the regulatory reporting system 100 of FIG. 1. The regulatory reporting system 402 includes an event log labeling module 418, a time series analysis module 420, an NLP-based classifier module 422, and an event analysis module 424. The memory 412 stores machine-readable instructions associated with the event log labeling module 418, the time series analysis module 420, the NLP-based classifier module 422, and the event analysis module 424. In various examples, the NLP-based classifier module 422 determines characteristics of an event (e.g., whether the event is reportable or not reportable, whether the event was planned or unplanned, whether equipment associated with the event was operable or inoperable, etc.) based on analysis of event logs in the event logs database 404, labels associated with the event logs by the event log labeling module 418, and/or descriptive text generated by the time series analysis module 420 based on time series data from the time series database 406. Based on events identified as reportable and the start, end, and/or duration of the reportable events as determined by the event analysis module 424, the event analysis module 424 generates a regulatory report indicating the reportable events and additional information associated with the reportable events (e.g., information such as that shown in FIG. 3, etc.).

The event logs database 404 includes operator event logs for a reporting time period (e.g., a month, etc.). Event logs in the event logs database 404 characterize portions of events associated with a nuclear power plant, such as the start of an event, progress of the event, or the end of the event. The time series database 406 includes data from other data sources such as equipment sensor data, work orders, outages, etc. that are associated with events during the reporting time period. Equipment sensor data includes time series data from a sensor that monitors an equipment, such as an equipment associated with an event. Depending on the example, the event logs database 404 and/or the time series database 406 can be stored locally to (e.g., stored within the memory 412, as shown in FIG. 4), remotely from (e.g., connected via the network 440, as shown in FIG. 4), or a combination of locally to and remotely from the computing environment 400. In various examples, data in the event logs database 404 is entered manually by operators. In various examples, data in the time series database includes data automatically generated (e.g., via signals received from equipment sensors, etc.).

The processor core 410 accesses the memory 412 and executes the machine-readable instructions as operations. The processor core 410 can be a variety of various processors including multiple single-and multi-core processors, co-processors, and other multiple single and multicore processor and co-processor architectures. The user I/O interface 414 provides software and hardware to facilitate data input and output between the computing environment 400 and a user. This can include input devices such as a keyboard, mouse, touchpad, touchscreen, microphone, etc., as well as output devices such as display(s) (e.g., light-emitting diode (LED) display panel(s), liquid crystal display (LCD) panel(s), plasma display panel(s), and/or touch screen display(s), etc.), speaker(s), etc. The user I/O interface 414 provides graphical input controls for a user interface, which can include software and hardware-based controls, interfaces, touch screens, or touch pads or plug and play devices for a user to provide user input.

The network interface 416 provides software and hardware to facilitate data input to (e.g., operator event logs input to the event log database 404, user feedback to event labels determined by the event log labeling module 418 and/or regulatory reports generated by the event analysis module 424, etc.) and output from (e.g., event labels determined by the event log labeling module 418 and/or regulatory reports generated by the event analysis module 424, etc.) the computing environment 400. The memory 412 includes the regulatory reporting system 402 that includes modules 418, 420, 422, and 424 that operate in concert and/or stages to generate a regulatory report that indicates reportable events during a reporting time period.

In various examples, the event log labeling module 418 determines a set of labels for each event log in a regulatory reporting time period in the event logs database 404 by applying a pattern matching algorithm to the event logs. In various examples, the labels indicate a type of equipment, an identifier of the equipment, a type of event, a characteristic or potential characteristic of the event, etc. The set of labels includes one or more labels selected from a pattern reference database (e.g., stored partially or wholly locally in memory 412 and/or remotely, etc.). Based on the set of labels, the event log labeling module 418 associates event logs with each other for analysis by the NLP-based classifier module 422 and the event analysis module 424.

The event log labeling module 418 employs the pattern matching algorithm via a weak supervision model that trains the pattern matching algorithm at least in part on user feedback (e.g., user feedback to a prior set of labels assigned by the pattern matching algorithm to a prior event log, etc.) received by the computing environment 400. Additionally, in examples, the event log labeling module 418 updates the pattern reference database in response to user feedback.

The time series analysis module 420 analyzes time series data for the reporting time period from the time series database 406 to extract discrete behavior and/or data (e.g., discrete data that characterizes the behavior of equipment associated with an event, etc.) from the analyzed time series data. In various examples, the analysis includes using one or more statistical techniques (e.g., applying an ARIMA model, etc.) on the time series data. The time series analysis module 420 extracts the discrete data/behavior by discretizing the result of the statistical analysis into a sequence of discrete behaviors (e.g., using an adaptive unsupervised segmentation, etc.). Based on the discrete data/behavior, the time series analysis module 420 employs a natural language generator (e.g., based on a transformer architecture, etc.) to generate descriptive text that characterizes the time series data, such as by transforming the features of each discrete event into the descriptive text using transformers. Based on characteristics of the time series data (e.g., an identity of the equipment monitored by the sensor that collected the time series data, etc.), the time series analysis module 420 associates the time series data, the extracted discrete behavior/data, and the descriptive text that characterizes the time series data with an event.

The NLP-based classifier module 422 analyzes event log(s) associated with an event (e.g., including labels assigned to the event log(s), etc.) and descriptive text that characterizes time series data associated with the event with a set of NLP-based classifiers to determine characteristics of the event. For an event, the NLP-based classifier module 422 classifies the event as reportable or not reportable per regulatory guidelines based on analyzing the event log(s) and/or descriptive text with a first NLP-based classifier. Additionally, in examples, the NLP-based classifier module 422 classifies the event as planned or unplanned based on analyzing the event log(s) and/or descriptive text with a second NLP-based classifier. In various examples, the NLP-based classifier module 422 also classifies equipment associated with the event as operable or inoperable based on analyzing the event log(s) and/or descriptive text with a third NLP-based classifier.

The event analysis module 424 performs semantic analysis on the event logs associated with an event and/or the descriptive text characterizing time series data associated with the event to determine the start, the end, and/or the duration of the event. In various examples, the event analysis module 424 employs a generative AI model to perform the semantic analysis. Additionally, based on the analysis of the events by the event analysis module 424 and the characteristics determined by the NLP-based classifier module 422, the event analysis module 424 generates a regulatory report (e.g., a preliminary report and/or a report ready for submission, etc.) that indicates events during the reporting time period that were classified as reportable. In various examples, a preliminary report generated by the event analysis module 424 is output to one or more users for review, feedback, and/or approval via the user I/O interface(s) 414 and/or the network 440. In the same or other examples, a finalized report (e.g., ready for submission, etc.) generated by the event analysis module 424 is uploaded to INPO IRIS or to WANO via the network 440.

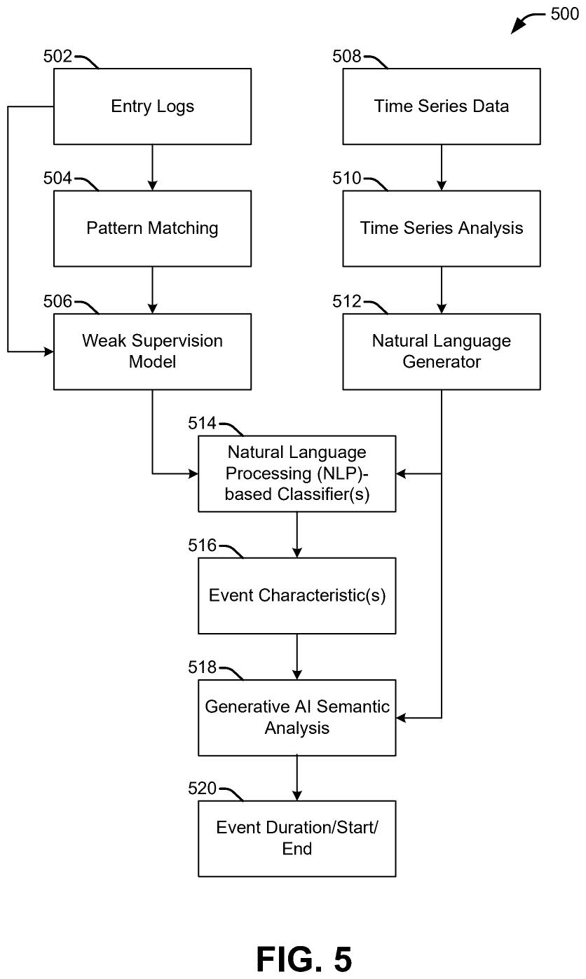

In view of the foregoing structural and functional features described above, an example method will be better appreciated with reference to FIGS. 5, 6, and 7. While, for purposes of simplicity of explanation, the example methods of FIGS. 5-7 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

Referring to FIG. 5, illustrated is a flow diagram of a method 500 for analyzing event logs and additional data sources associated with a nuclear power plant in connection with generating a regulatory report. In other examples, the blocks of the example method 500 are a set of machine-readable instructions on a non-transitory machine-readable medium or are a set of operations performed by a processor executing machine-readable instructions as the operations.

At block 502, the method 500 includes receiving entry logs associated with a nuclear power plant during a reporting time period (e.g., a month, etc.), such as by accessing a database of operator event logs (e.g., event logs database 110, etc.) that includes entries made by operators during the reporting time period. At block 504, the method 500 includes applying a pattern matching algorithm to event logs to determine a set of labels for each event log. In various examples, the set of labels determined for an event log includes one or more labels selected from a pattern reference database and/or one or more additional labels. Example labels include a type of equipment (e.g., an emergency diesel generator (EDG), etc.), an identifier of an equipment (e.g., 3B EDG, etc.), a type of an event, a characteristic of an event (e.g., operable/inoperable, planned/unplanned, etc.), etc.

At block 506, the method 500 includes training the pattern matching algorithm via a weak supervision model. In various examples, training includes initial training, for example, based on an initial dataset, such as of event logs from earlier reporting time periods, some of which are associated with known labels. In the same or other examples, training includes user feedback, for example, user feedback to labels determined for event logs in a first reporting time period are used in examples to train the pattern matching algorithm to generate a set of labels for event logs in a second reporting time period after the first reporting time period. Additionally, in various examples, the pattern reference database is also updated based on user feedback.

At block 508, the method 500 includes receiving event data from additional data sources, such as by accessing time series data for the reporting time period stored in a time series database 120 (e.g., equipment sensor data, work orders, outages, etc.). At block 510, the method 500 includes analyzing the time series data to extract discrete data and/or behaviors from the time series data, for example, by employing one or more statistical techniques (e.g., applying an ARIMA model, etc.). At block 512, the method 500 includes applying a natural language generator (NLG) (e.g., based on a transformer architecture, etc.) to the discrete data/behavior extracted at 510 to generate descriptive text for the discretized data/behavior.

At block 514, the method 500 includes analyzing the event logs (e.g., as received at block 502), sets of labels (e.g., as determined at block 504), and/or descriptive text associated with an event (e.g., as generated at block 512) via a set of NLP-based classifiers, such as a first NLP-based classifier that classifies the event as reportable or not reportable, a second NLP-based classifier that classifies the event as planned or unplanned, a third NLP-based classifier that classifies equipment associated with the event as operable or inoperable, etc.

At block 516, the method 500 includes assigning one or more attributes and/or characteristics (e.g., reportable or not reportable, planned or unplanned, whether equipment associated with the event was operable or inoperable, etc.) to the event based on the set of NLP-based classifiers. At block 518, the method 500 includes performing semantic analysis on the descriptive text, event logs, and/or sets of labels of event logs, such as via a generative AI model. Based on the semantic analysis, different event logs and/or other sources of data associated with the event are correlated. In some examples, missing data that should be associated with the event is identified, based on the analyzed event logs and/or other sources of data. In some examples, missing data (e.g., due to event log(s) with typographical errors not being associated with the event, etc.) is identified when an event log indicating a start of the event or an end of the event is not among event logs associated with the event, or when the event has a regular pattern of event logs (e.g., at regular intervals of time, etc.) that is interrupted by a missing event log. Based on the identified missing data, one or more event logs that are potentially associated with the event are able to be determined (e.g., via the AI model or via manual review of an automatically identified time frame for the missing data, etc.). At block 520, the method 500 includes defining the start of the event, the end of the event, and the duration of the event based on the semantic analysis.

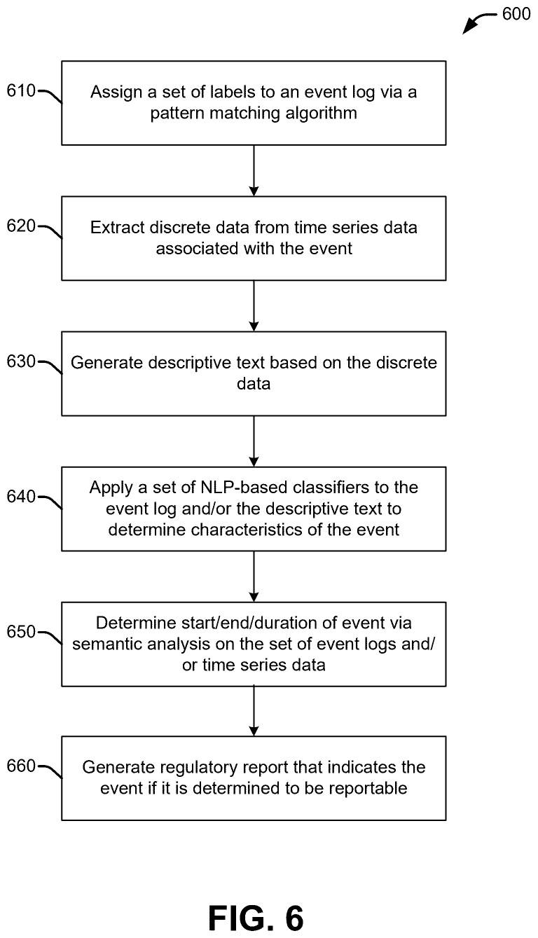

FIG. 6 illustrates a flowchart of an example method 600 for generating a regulatory report for a nuclear power plant. In other examples, the blocks of example method 600 are a set of machine-readable instructions on a non-transitory machine-readable medium or are a set of operations performed by a processor executing machine-readable instructions as the operations.

At block 610, the method 600 includes assigning a set of labels to an event log (e.g., an event log from the event logs database 110 associated with a reporting time period, etc.) associated with an event via a pattern matching algorithm (e.g., applied by the event log labeling module 418, which trains the pattern matching algorithm via a weak supervision model, etc.) that employs a pattern reference database (e.g., wherein the pattern reference database is updated by the event log labeling module 418 based on user feedback, etc.). At block 620, the method 600 includes extracting discrete data from time series data (e.g., via the time series analysis module 420, etc.) associated with the event (e.g., from an equipment sensor monitoring equipment associated with the event, etc.). In some examples, the discrete data is extracted by applying one or more statistical techniques (e.g., an ARIMA model, etc.) to the time series data and discretized into a sequence of discrete behaviors via adaptive unsupervised segmentation.

At block 630, the method 600 includes generating descriptive text (e.g., via the time series analysis module 420, etc.) based on the discrete data/behavior extracted from the time series data associated with the event. In various examples, the descriptive text is generated via a natural language generator, which can employ a transformer architecture. In various examples, in addition to the extracted discrete behavior/data, the natural language generator also generates the descriptive text based on metadata associated with the time series data (e.g., a type and/or identifier of the equipment monitored by the sensor that generated the time series data, etc.).

At block 640, the method 600 includes applying a set of NLP-based classifiers (e.g., via the NLP-based classifier module 422, etc.) to a set of text associated with an event (e.g., the event logs and associated sets of labels and/or the descriptive text generated for time series data, etc.) to determine one or more characteristics for the event, such as whether the event is reportable or not reportable, whether the event was planned or unplanned, whether equipment associated with the event was operable or inoperable during the event, etc.

At block 650, the method 600 includes determining the start, end, and/or duration of the event via semantic analysis (e.g., via the event analysis module 424, etc.) of the set of event logs, labels, time series data and/or descriptive text associated with the event. In various examples, the semantic analysis is performed via a generative AI, such as one with a transformer architecture.

At block 660, the method includes generating a regulatory report (e.g., via the event analysis module 424, etc.) that indicates events during the reporting time period that were determined to be reportable, along with additional information regarding those events (e.g., planned/unplanned, associated with operable/inoperable equipment, location, time, etc.).

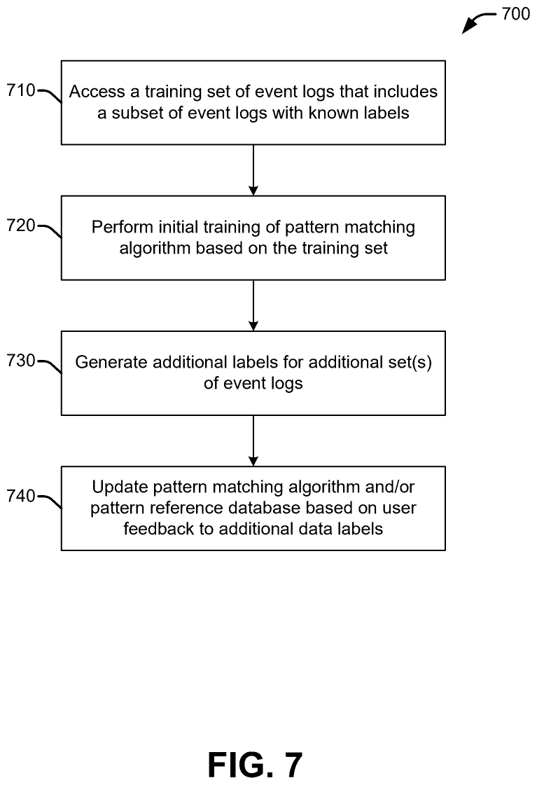

FIG. 7 illustrates a flowchart of an example method 700 for training and employing a pattern matching algorithm to generate a set of labels for an event log related to a nuclear power plant. In other examples, the blocks of example method 700 are a set of machine-readable instructions on a non-transitory machine-readable medium or are a set of operations performed by a processor executing machine-readable instructions as the operations.

At block 710, the method 700 includes accessing (e.g., via the event log labeling module 418, etc.) a training set of event logs. In various examples, the training set of event logs includes a subset of event logs (e.g., some or all of the event logs of the training set) with known labels (e.g., ground truth labels, etc.). In various examples, an initial state of a pattern reference database is provided.

At block 720, the method 700 includes performing initial training of the pattern matching algorithm (e.g., via the event log labeling module 418, etc.) based on the training set.

At block 730, the method 700 includes generating additional labels (e.g., via the event log labeling module 418, etc.) for one or more additional sets of event logs (e.g., from an event logs database 110, such as labels generated during data analysis in connection with a regulatory report as in method 500 of FIG. 5 and/or generation of a regulatory report as in method 600 of FIG. 6, etc.).

At block 740, the method 700 includes updating (e.g., via the event log labeling module 418, etc.) the pattern matching algorithm (e.g., via further training, etc.) and/or the pattern reference database (e.g., adding, removing, and/or changing one or more entries, etc.) based on user feedback to the additional data labels.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Also as used herein, the term “set” means one or more elements (e.g., where the elements can be anything, such as datasets, nodes, relationships, etc.), and a “subset” of a set A refers to any set B where every element of set B is an element of set A (note that every set A is a subset of itself, as every element of set A is an element of set A). Similarly, a “proper subset” of set A refers to a set B that does not include every member of the set A, such that set A and set B are not equal. Additionally, where the disclosure or claims recite “a,” “an,” “a first,” or “another” element, or the equivalent thereof, it should be interpreted to include one or more than one such element, neither requiring nor excluding two or more such elements.

In this description, unless otherwise stated, “about,” “approximately” or “substantially” preceding a parameter means being within +/−10 percent of that parameter. Modifications are possible in the described embodiments, and other embodiments are possible, within the scope of the claims.

What is claimed is:

1. A non-transitory machine-readable medium having machine executable instructions for a regulatory reporting system that causes a processor core to execute operations, the operations comprising:
assigning a set of labels to an event log of a set of event logs based on applying a pattern matching algorithm to the event log, wherein the event log characterizes a portion of an event associated with a nuclear power plant;
employing a natural language processor (NLP)-based classifier of a set of NLP-based classifiers to determine whether the event is reportable, wherein the NLP-based classifier determines whether the event is reportable based on analyzing the set of labels; and
generating a regulatory report based on the set of event logs, wherein, in response to a determination that the event log is reportable, the regulatory report indicates the event.

2. The non-transitory machine-readable medium of claim 1, wherein the NLP-based classifier is a first NLP-based classifier and the set of NLP-based classifiers comprises a second NLP-based classifier, and wherein the operations further comprise:
employing the second NLP-based classifier of the set of NLP-based classifiers to determine whether an equipment associated with the event is operable, wherein the second NLP-based classifier determines whether the equipment associated with the event is operable based on analyzing the set of labels.

3. The non-transitory machine-readable medium of claim 1, wherein the NLP-based classifier is a first NLP-based classifier and the set of NLP-based classifiers comprises a second NLP-based classifier, and wherein the operations further comprise:
employing the second NLP-based classifier of the set of NLP-based classifiers to determine whether the event was planned, wherein the second NLP-based classifier determines whether the event was planned based at least in part on analyzing the set of labels.

4. The non-transitory machine-readable medium of claim 1, wherein the operations further comprise:
analyzing time series data from a sensor that monitors an equipment associated with the event to extract discrete data that characterizes the behavior of the equipment; and
generating descriptive text that characterizes the time series data by applying a natural language generator to the discrete data,
wherein the NLP-based classifier determines whether the event is reportable based on analyzing the descriptive text.

5. The non-transitory machine-readable medium of claim 4, wherein the time series data is analyzed based on an autoregressive integrated moving average (ARIMA) model.

6. The non-transitory machine-readable medium of claim 4, wherein the natural language generator has a transformer architecture.

7. The non-transitory machine-readable medium of claim 1, wherein the operations further comprise analyzing the event log and an additional event log of the set of event logs to determine a start of the event, an end of the event, and a duration of the event.

8. The non-transitory machine-readable medium of claim 7, wherein analyzing the event log and the additional event log to determine a start of the event, an end of the event, and a duration of the event comprises employing a generative artificial intelligence to perform semantic analysis on the event log and the additional event log.

9. The non-transitory machine-readable medium of claim 1, wherein the pattern matching algorithm is employed by a weak supervision model.

10. The non-transitory machine-readable medium of claim 9, wherein the weak supervision model is trained based on user feedback to a prior set of labels assigned by the pattern matching algorithm to a prior event log of the set of event logs, wherein the prior event log was added to the set of event logs before the event log.

11. The non-transitory machine-readable medium of claim 10, wherein the set of labels are selected from a pattern reference database, and the pattern reference database is updated based on the user feedback.

12. The non-transitory machine-readable medium of claim 1, wherein the regulatory report is formatted for upload to a regulatory authority.

13. A regulatory reporting system, comprising:
a memory for storing machine-readable instructions; and
a processor core for accessing the machine-readable instructions and executing the machine-readable instructions as operations, the operations comprising:
assigning a set of labels to an event log of a set of event logs based on applying a pattern matching algorithm to the event log, wherein the event log characterizes a portion of an event associated with a nuclear power plant;
employing a natural language processor (NLP)-based classifier of a set of NLP-based classifiers to determine whether the event is reportable, wherein the NLP-based classifier determines whether the event is reportable based on analyzing the set of labels; and
generating a regulatory report based on the set of event logs, wherein, in response to a determination that the event log is reportable, the regulatory report indicates the event.

14. The regulatory reporting system of claim 13, wherein the operations further comprise:
analyzing time series data from a sensor that monitors an equipment associated with the event to extract discrete data that characterizes the behavior of the equipment; and
generating descriptive text that characterizes the time series data by applying a natural language generator to the discrete data,
wherein the NLP-based classifier determines whether the event is reportable based on analyzing the descriptive text.

15. The regulatory reporting system of claim 13, wherein the operations further comprise analyzing the event log and an additional event log of the set of event logs to determine a start of the event, an end of the event, and a duration of the event.

16. The regulatory reporting system of claim 13, wherein the NLP-based classifier is a first NLP-based classifier and the set of NLP-based classifiers comprises a second NLP-based classifier, and wherein the operations further comprise:
employing the second NLP-based classifier of the set of NLP-based classifiers to determine whether the event was planned, wherein the second NLP-based classifier determines whether the event was planned based at least in part on analyzing the set of labels.

17. The regulatory reporting system of claim 13, wherein the NLP-based classifier is a first NLP-based classifier and the set of NLP-based classifiers comprises a second NLP-based classifier, and wherein the operations further comprise:
employing the second NLP-based classifier of the set of NLP-based classifiers to determine whether an equipment associated with the event is operable, wherein the second NLP-based classifier determines whether the equipment associated with the event is operable based on analyzing the set of labels.

18. A method for generating a regulatory report, the method comprising:
assigning a set of labels to an event log of a set of event logs based at least in part on applying a pattern matching algorithm to the event log, wherein the event log characterizes at least a portion of an event associated with a nuclear power plant;
analyzing time series data from a sensor that monitors an equipment associated with the event to extract discrete data that characterizes the behavior of the equipment;
generating descriptive text that characterizes the time series data by applying a natural language generator to the discrete data;
employing a natural language processor (NLP)-based classifier of a set of NLP-based classifiers to determine whether the event is reportable, wherein the NLP-based classifier determines whether the event is reportable based at least in part on analyzing the set of labels and the descriptive text; and
generating a regulatory report based on the set of event logs, wherein, in response to a determination that the event log is reportable, the regulatory report indicates the event.

19. The method of claim 18, further comprising analyzing the event log and an additional event log of the set of event logs via semantic analysis to determine a start of the event, an end of the event, or a duration of the event.

20. The method of claim 18, wherein the pattern matching algorithm is employed by a weak supervision model that is trained based at least in part on user feedback to a prior set of labels assigned by the pattern matching algorithm to a prior event log.
